(19) United States
(12) Patent Application Publication
(10) Pub. No.: US 2017/0076428 A1
(43) Pub. Date: Mar. 16, 2017

(54) INFORMATION PROCESSING APPARATUS

(71) Applicant: CANON KABUSHIKI KAISHA, Tokyo (JP)

(72) Inventors: Rei Ishikawa, Gordon (AU); Yasuo Okutani, Kawasaki-shi (JP)

(21) Appl. No.: 15/263,931

(22) Filed: Sep. 13, 2016

(30) Foreign Application Priority Data
Sep. 14, 2015 (JP) 2015-180978
Mar. 15, 2016 (JP) 2016-051570

(51) Int. Cl. G06T 3/40; H04N 5/225; H04N 9/31

(52) U.S. Cl. CPC G06T 3/4007; H04N 9/3188; H04N 5/225; G06T 2200/28

(57) ABSTRACT

Provided is an information processing apparatus configured to improve visibility for a user when presentation information is projected and displayed on a target object. The information processing apparatus includes an image capture device and a display device. The information processing apparatus recognizes marker IDs and positions of markers included in a captured image obtained via the image capture device, and determines whether or not one or more markers are included in the captured image (Step S203). When one or more markers are included in the captured image (Step S203: Y), a related information acquisition unit acquires related information corresponding to the marker IDs (Step S204). At this stage, a distance between the information processing apparatus and each marker is calculated based on a size of the markers included in the image (Step S212).

### BACKGROUND OF THE INVENTION

### Field of the Invention

The present invention relates to an information processing apparatus, and to a technology for displaying information on an object recognized from a video.

### Description of the Related Art

Hitherto, there has been known a technology for projecting and displaying related information (such related information is also referred to as augmented information) on a target that a user is focusing on. For example, in Japanese Patent Application Laid-open No. 08-86615, there is disclosed a technology for capturing a target object, retrieving related information on the captured target object, and projecting the retrieved related information on the target object. In that technology, a position and a shape of the target object are detected, and the retrieved related information is projected on the target object based on the detected position and shape.

In US 2012/0313974, there is proposed a technology for changing, when projecting information, a size and a position of an image to be projected in accordance with a distance from an apparatus projecting the information to a projection target.

When projecting on an object existing in the real world related information on that object, the amount of related information that is easily viewed by the user depends on a projection environment. For example, for a mobile projection device capable of being carried around by the user, the distance between the user and the object serving as a projection surface varies. In general, the range of the projection surface over which projection light is irradiated becomes wider as the projection apparatus moves further away from the projection surface while the projection apparatus continues to project the same image. At this time, on the projection surface, the characters and images included in a projection image look bigger. However, when an object existing in the real world is used as the projection surface, the size of the object does not change regardless of the distance between the user and the projection surface. Therefore, the object appears relatively smaller with respect to the projection image, which becomes larger and larger, as the user moves further away from the projection surface. More specifically, when the distance between the user and the projection surface is larger, the partial area on which the related information on the object is to be projected becomes smaller with respect to the overall projection image. In a situation in which the size of the projection range is limited, when there is a large amount of information to be projected, it becomes more difficult to view the content of that information.

In Japanese Patent Application Laid-open No. 08-86615, there is disclosed a technology for generating, when projecting information, projection content based on a relative position between an apparatus and a projection target. However, in Japanese Patent Application Laid-open No. 08-86615, there is no disclosure about changing the amount of related information to be projected in accordance with the projection environment.

In US 2012/0313974, there is a disclosure about changing the size and the position of the projection image in accordance with the distance to the projection surface, but there is no disclosure about changing the amount of related information to be projected based on the projection environment. The present invention has been created in view of the problems described above. It is an object of the present invention to, when related information on an object is to be projected on the object in an environment in which the distance between a projection apparatus and the object to serve as a projection surface is variable, improve the visibility of the related information.

### SUMMARY OF THE INVENTION

According to the present disclosure, an information processing apparatus comprises: an image capture unit configured to capture a target object; a generation unit configured to generate, by using a captured image captured by the image capture unit, presentation information for displaying related information corresponding to the target object at a position specified based on a position of the target object; an image display unit configured to display an image including the generated presentation information; and a distance acquisition unit configured to acquire a distance between the target object and the information processing apparatus, wherein the generation unit is configured to generate, when the captured image and the distance acquired by the distance acquisition unit are larger than predetermined values, the presentation information by changing an amount of information to be included in the presentation information.

Further features of the present invention will become apparent from the following description of exemplary embodiments (with reference to the attached drawings).

### BRIEF DESCRIPTION OF THE DRAWINGS

FIG. 1A is a hardware configuration diagram of an information processing apparatus according to a first embodiment of the present invention.

FIG. 1B is a function block diagram for illustrating functions formed in the information processing apparatus.

FIG. 2A is a flowchart for illustrating processing according to the first embodiment.

FIG. 2B is a flowchart for illustrating processing for generating presentation information.

FIG. 3A is a table for showing an example of related information.

FIG. 3B and FIG. 3C are illustrations of examples of the generated presentation information.

FIG. 3D and FIG. 3E are explanatory diagrams of projection results.

FIG. 4A is a flowchart for illustrating processing for generating presentation information corresponding to a single marker.

FIG. 4B and FIG. 4C are illustrations of examples of the generated presentation information.

FIG. 4D and FIG. 4E are explanatory diagrams of projection results.

FIG. 5A is a flowchart for illustrating processing for generating presentation information on a plurality of markers.

FIG. 5B and FIG. 5C are illustrations of examples of the generated presentation information.

FIG. 5D and FIG. 5E are explanatory diagrams of examples of projection results.

FIG. 6A is a flowchart for illustrating processing for generating presentation information corresponding to a plurality of markers.

FIG. 6B and FIG. 6C are illustrations of examples of the generated presentation information.

FIG. 6D and FIG. 6E are explanatory diagrams of projection results.

FIG. 7 is an explanatory diagram of a projection image.

FIG. 8A, FIG. 8B, and FIG. 8C are explanatory diagrams of examples of marker groups of a target for which presentation information is to be generated according to a second embodiment of the present invention.

FIG. 9A is a flowchart for illustrating processing for determining the marker groups.

FIG. 9B is an expression for calculating an inter-marker distance.

FIG. 10 is an explanatory diagram of a projection result of presentation information when grouping is performed based on a value of the inter-marker distance and a value of an item according to the second embodiment.

FIG. 11A, FIG. 11B, and FIG. 11C are explanatory diagrams of projection results of presentation information when an upper limit of a number of pieces of presentation information is set according to the second embodiment.

FIG. 12A, FIG. 12B, and FIG. 12C are explanatory diagrams of projection results of presentation information when presentation information on a group near a center of projection is prioritized according to the second embodiment.

FIG. 13A, FIG. 13B, and FIG. 13C are explanatory diagrams of projection results when rough grouping is performed according to the second embodiment.

FIG. 14A, FIG. 14B, FIG. 14C, and FIG. 14D are explanatory diagrams of projection results of presentation information when information is presented based on time sharing according to the second embodiment.

FIG. 15A, FIG. 15B, and FIG. 15C are explanatory diagrams of projection results of presentation information when an amount of information is reduced by not using characters according to the second embodiment.

### DESCRIPTION OF THE EMBODIMENTS

### First Embodiment

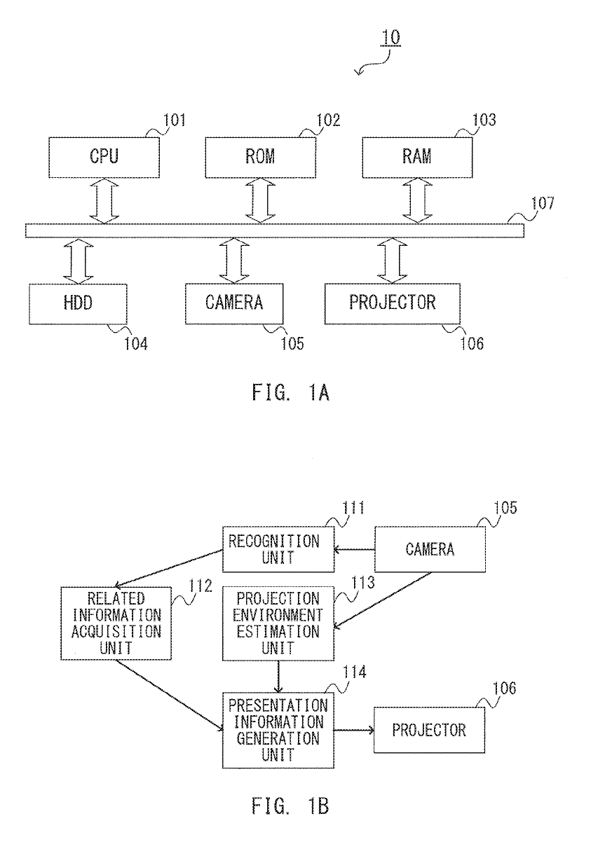

FIG. 1A is a hardware configuration diagram of an information processing apparatus 10 according to a first embodiment of the present invention. The information processing apparatus 10 includes, as functional components, a central processing unit (CPU) 101, a read-only memory (ROM) 102, and a random-access memory (RAM) 103. The information processing apparatus 10 also includes a hard disk drive (HDD) 104, and as functional components, a camera 105 serving as an optical image capture unit and a projector 106 serving as an optical image projection unit. Each functional component is capable of passing data to and from each of the other components via a bus 107.

The CPU 101 is configured to control each of the hardware components by reading and executing a program stored in the ROM 102 and the HDD 104.

The program may be, for example, a control program for implementing each of the functions, sequences, and processing steps that are described later. That control program and various types of data to be referenced during execution of the control program are recorded in the ROM 102. The RAM 103 includes, for example, a work area to be used by the CPU 101, a load area for the control program.

The HDD 104 is a type of storage. The HDD 104, which is configured to store the control program, is read as appropriate by the CPU, for example. The camera 105 is configured to capture an image of a target object serving as a captured target, and to store the captured image in the RAM 103 and the HDD 104. The projector 106 is configured to project information stored in the RAM 103 and the HDD 104. The camera 105 and the projector 106 are mounted to the information processing apparatus 10 so that a photographable range of the camera 105 and a projectable range of the projector 106 overlaps. The bus 107 is configured to transfer, for example, address signals instructing the components to be controlled by the CPU 101, control signals for controlling each of the components, and data to be passed to and from each of the devices.

The control program may be recorded in advance in the ROM 102 or the HDD 104, or may be stored as necessary in the ROM 102 or the HDD 104 from an external apparatus, an external recording medium, for example. The CPU 101 is configured to implement each function by executing the control program recorded in the ROM 102 or the HDD 104.

In this embodiment, a projector is used as an example of an image display unit. However, the present invention is not limited to this example, and may use any device capable of displaying a live view image, e.g., a head-mounted display, a smartphone, or a tablet computer.

FIG. 1B is a function block diagram for illustrating functions formed in the information processing apparatus 10 by the CPU 101 executing the control program. In this embodiment, the CPU 101 is configured to form function modules, including a recognition unit 111, a related information acquisition unit 112, a projection environment estimation unit 113, and a presentation information generation unit 114.

The recognition unit 111 is configured to recognize an object identification (ID) and a position of an object having a specific shape included in the captured image captured by the camera 105. In this embodiment, a marker is used as the object having a specific shape, and a marker ID is used as the object ID. The marker is a specific pattern in which information, such as numerical values and characters, are embedded. As a representative example, a one-dimensional barcode or a two-dimensional barcode may be used. The marker ID is information embedded in the marker. The marker ID is used as an ID for distinguishing markers having different patterns.

The related information acquisition unit 112 is configured to acquire related information associated with a recognized marker ID. A correspondence relation between the marker ID and the related information is stored in advance in the ROM 102 or the HDD 104. Related information stored in a server external to the information processing apparatus 10 may also be acquired by using a communication device. In this embodiment, pairs of one or more items and a value classified for any one of those items are associated as the related information with each individual marker ID. In this embodiment, in particular, information on the content of a container to which a marker has been applied is associated as the related information. The term “container” as used herein refers to a physical object capable of storing articles in its interior. A representative example of such a container is a box. For example, for one marker ID, related information on a plurality of items, such as a “product name”, a “size”, and a “color”, of the article, which is the content of the container to which that marker has been attached, may be associated.

The projection environment estimation unit 113 is configured to estimate, based on the captured image, information on environmental factors influencing projection (hereinafter referred to as “projection environment”), such as a distance between the information processing apparatus 10 and a projection surface, a color of the projection surface, and ambient light. The presentation information generation unit 114 is configured to group the related information, and to generate presentation information based on the grouped related information. The projector 106 is configured to receive the presentation information from the presentation information generation unit 114, and to project the received presentation information. The presentation information is information representing the content of the related information to be presented to the user. For example, the related information is information output as an image to the projector 106 in order to be presented to the user. In this embodiment, in particular, information (related information) on the content of the container (e.g., box) to which a marker has been attached is presented on and around that container. As a result, the user can visually obtain information on the contents of the container by turning the information processing apparatus 10 toward the container.

In this embodiment, a plurality of markers may be recognized at the same time, and a plurality of pieces of presentation information may be simultaneously projected. Therefore, the term “presentation information” may refer to each of a plurality of partial images included in an image representing one screen output by the projector 106. The presentation information generation unit 114 is configured to change the number of pieces of presentation information and the amount of information contained in the presentation information based on the projection environment. For example, even when there are a plurality of marker IDs that have been recognized, depending on the projection environment, control is performed for consolidating into one piece of presentation information to be projected.

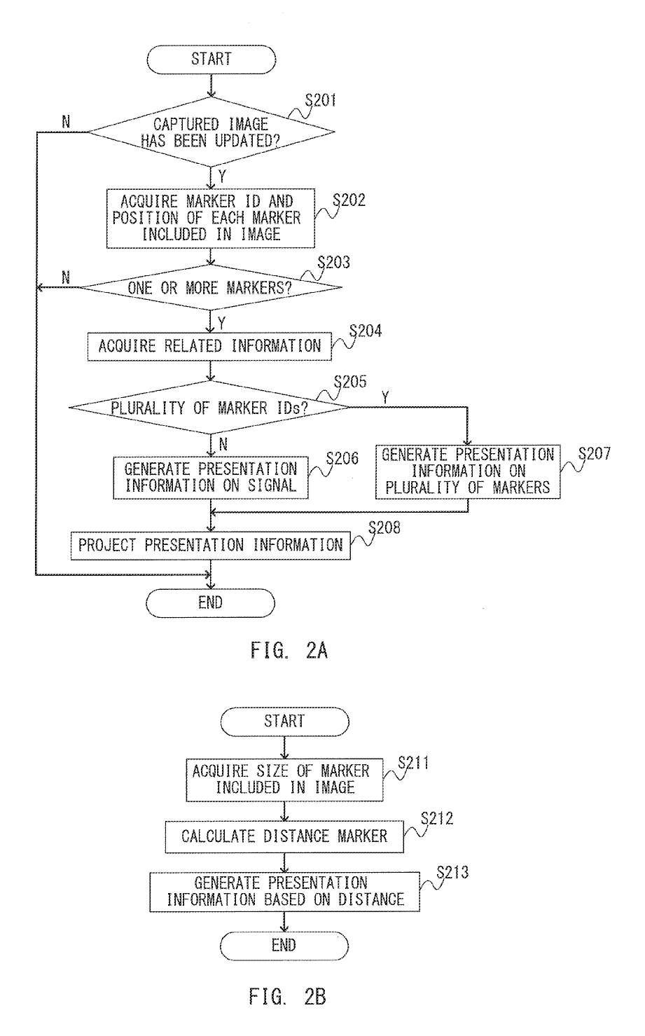

Next, an operation example of the information processing apparatus 10 configured as described above is described. FIG. 2A is a flowchart for illustrating processing executed by each function component included in the information processing apparatus 10. The CPU 101 is configured to execute the processing at fixed time intervals. Unless stated otherwise, all of the processing steps described below are executed by the CPU 101 via the recognition unit 111, the related information acquisition unit 112, for example.

As illustrated in FIG. 2A, the recognition unit 111 recognizes the captured image obtained via the camera 105, and determines whether or not the captured image has been updated since the previous time processing was executed (Step S201). When this sequence is executed for the first time after the information processing apparatus 10 is started, the captured image is determined as having been updated. When the captured image has not been updated (Step S201: N), the CPU 101 ends this sequence. When the captured image has been updated (Step S201: Y), the recognition unit 111 acquires the marker ID and the position of each marker included in the captured image (Step S202). The marker IDs and the positions may be acquired by image recognition, for example.

Next, the recognition unit 111 determines whether or not one or more markers are included in the captured image (Step S203). When there are no markers included in the captured image (Step S203: N), the CPU 101 ends this sequence.

When a marker is included in the captured image (Step S203: Y), the related information acquisition unit 112 acquires the related information corresponding to the marker ID of each marker recognized by the recognition unit 111 in Step S202 (Step S204). Next, the presentation information generation unit 114 determines whether or not there are a plurality of marker IDs (Step S205). An example of a case in which there are a plurality of marker IDs is when a box having a marker printed on each side is lifted up, and the lifted-up surface serves as the projection surface. When information on the objects (products) contained in the box is associated with the marker IDs in advance, detailed information on the contents of the box may be referenced as necessary by using the information processing apparatus 10 without opening the box.

When there is one marker ID (Step S205: N), the presentation information generation unit 114 generates presentation information for a single marker (Step S206). When there are a plurality of marker IDs (Step S205: Y), the presentation information generation unit 114 performs processing for generating presentation information for each of the plurality of markers (Step S207). The processing for generating the presentation information may also be performed on information corresponding to the plurality of markers as a whole. As described later, the determination regarding which processing method is to be used may be performed based on the content of the related information associated with the markers or based on the distances between the markers and the information processing apparatus 10. Lastly, the presentation information generation unit 114 instructs the projector 106 to project the presentation information (Step S208), and then ends the processing.

In Step S202, the recognition unit 111 acquires the marker ID and the position of each marker included in the captured image. That example is based on the assumption that the captured area and the projection area of the projector 106 match, or that the captured area is smaller than the projection area. However, the captured area may be wider than the projection area. In such a case, the marker ID and the position of each marker included in the captured image and in the projection area may be acquired. As a method of acquiring the projection area in the captured image, a known method may be used. As a simple method, all pixels are projected in red by the projector 106, and the projected image is captured by an image capture apparatus. The projection area in the captured image may be determined by taking the range in which the pixels are red in the captured image to be the projection area.

FIG. 2B is a flowchart for illustrating the details of generating the presentation information for a single marker in Step S206 of FIG. 2A. The projection environment estimation unit 113 acquires the size of the marker included in the captured image (Step S211). Next, the presentation information generation unit 114 calculates a projection distance between the marker and the information processing apparatus 10 by using the size of the marker included in the captured image (Step S212). As the method of acquiring the distance, when the actual size of the marker is known in advance, the distance to the marker appearing in the captured image may be calculated based on the field of view of the camera 105 and the number of pixels in the captured image.

For example, when the horizontal field of view is 90 degrees and the number of pixels in the captured image is 640 pixels (width) by 480 pixels (height), a one meter-long target object at a distance of 1 m appears as 320 pixels in the captured image. When the marker width is known in advance to be 10 cm, if the marker width in the captured image is 32 cm, the distance can be estimated to be 1 m, and if the marker width in the captured image is 20 cm, the distance can be estimated to be 1.6 m. In general, the angle of view and the number of pixels used for the estimation are determined based on the characteristics of a lens and an image sensor, which are each one of the components of the camera 105.

Next, the presentation information generation unit 114 generates the presentation information in accordance with the related information corresponding to the marker, the distance to the marker, and the position of the marker (Step S213), and then ends the processing.

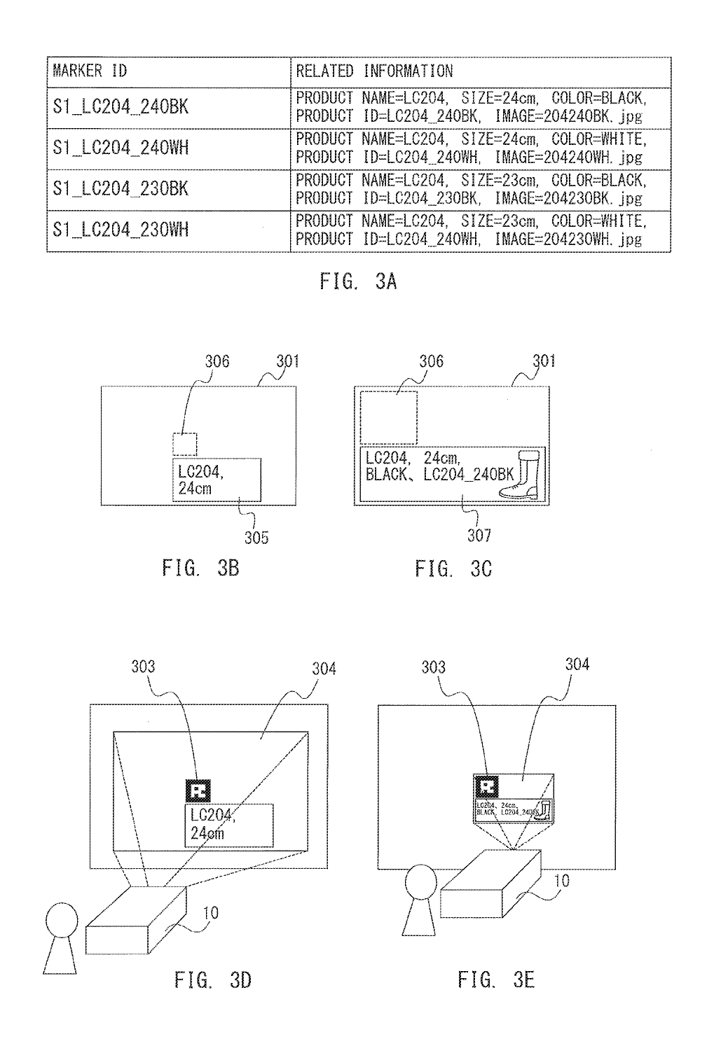

FIG. 3A is a table for showing an example of the related information acquired by the related information acquisition unit 112 in Step S204 of FIG. 2A. In this embodiment, the related information is uniquely defined for each marker ID. Further, in this embodiment, a plurality of pairs of items and values are contained in the related information. For example, as shown in FIG. 3A, for a marker ID “S1_LC204_240BK”, there are five pairs of items and values contained in the related information.

In this marker, the value for the item “product name” is “LC204”, the value for the item “size” is “20 cm”, the value for the item “color” is “black”, the value for the item “product ID” is “LC204_240BK”, and the value for the item “image” is “202240BK.jpg”. Those values may be set to arbitrary information, and character information or image information may be used for those values. In the example shown in FIG. 3A, image information is used for the value of the “image” item.

FIG. 3B is an illustration of an example of the projection image, and the presentation information contained in that projection image, which are generated in Step S213 of FIG. 2B by the presentation information generation unit 114 based on the related information shown in FIG. 3A when the distance between the information processing apparatus 10 and the marker is 2 m. In FIG. 3B and FIG. 3C, a projection image 301 is a projection image projected by the projector 106 on the target object captured by the camera 105. Presentation information 305 represents the presentation information in the projection image 301 when the distance between the information processing apparatus 10 and the marker is 2 m. A marker area 306 indicated by a square-shaped area represents, of the projection image 301, the position and the size of a portion to be superimposed on a marker that exists in the real world (marker having the marker

The marker area 306 is an area defined in order to perform positioning processing when the projection image is output by the information processing apparatus 10 so as to be superimposed on a marker in the real world. The marker area 306 is not represented as an image on the projection image. In FIG. 3B and FIG. 3C, the marker area 306 is indicated by a dotted line in order to distinguish the marker area 306 from text and graphics represented as images. Positioning processing is thus performed by arranging in the projection image a marker area that takes into account the position and the size of the marker in the real world. As a result, the related information can be projected near the target object in the real world. In this case, “near the target object” refers to a range close to at least the target object, and includes a range overlapping the target object.

FIG. 3C is an illustration of an example of the presentation information generated in Step S213 of FIG. 2B by the presentation information generation unit 114 based on the related information shown in FIG. 3A when the distance between the information processing apparatus 10 and the marker is 1 m. In FIG. 3C, presentation information 307 represents the presentation information in the projection image 301 when the distance between the information processing apparatus 10 and the marker is 1 m. Similar to FIG. 3B, the marker area 306 indicated by a square-shaped area represents, of the projection image 301, the position and the size of the portion to be superimposed on the marker having the marker ID S1 LC204_240BK.

In this embodiment, because the presentation information generation unit 114 is configured to not generate an image of the marker in the projection image 301, the image of the marker is not itself illustrated in FIG. 3B and FIG. 3C. In FIG. 3B and FIG. 3C, the marker area 306 is generated so that the marker does not overlap in the marker area 306 when the projection image 301 is projected on the target object captured by the camera 105.

As illustrated in FIG. 3B and FIG. 3C, the presentation information generation unit 114 is configured to generate presentation information containing a larger amount of related information when the distance between the information processing apparatus 10 and the marker is closer. In this embodiment, the presentation information generation unit 114 is configured to include, when the distance is 1.5 m or more and less than 2.0 m, three of the values among the related information in one piece of presentation information. As illustrated in FIG. 3B, the presentation information generation unit 114 is configured to include, when the distance is 2.0 m or more, two of the values among the related information, namely, “LC204” and “24 cm”, in one piece of presentation information. In those examples, the amount of information is counted by matching the number of values of the related information, but the amount of information may also be counted based on the number of items. As illustrated in FIG. 3C, the presentation information generation unit 114 is configured to generate, when the distance between the information processing apparatus 10 and the marker is less than 1.5 m, presentation information containing all the pieces of related information, namely, “LC204”, “24 cm”, “black”, “LC204_240BK”, and image.

The position and the size of the marker in the projection image are calculated by using a correction parameter to convert the position and the size of the marker area 306 included in the captured image. In general, the camera 105 and the projector 106 in the information processing apparatus 10 have a mounted position, a projection angle, and a lens focal length that are different from each other.

As a result, even when the target object is captured by the camera 105, and the captured image is projected as it is by the projector 106, the target object appearing in the captured image is not projected in the same position and the same size as the actual target object. In order to project information matching the position and the size of the target object included in the captured image, it is necessary for the shape of the marker included in the captured image to be converted into the shape in the projection image. The correction parameter used for the conversion may be determined based on, for example, an image obtained by the camera 105 capturing a test pattern image projected by the projector 106.

Through converting in this manner, when information is projected on the marker area 306 in the captured image, that information is superimposed on a marker 303, which is illustrated in FIG. 3D and FIG. 3E described later, in the real world. Further, as described above, the marker 303 is positioned in the marker area 306, but the marker area 306 itself is not displayed on the projection image. In this example, the presentation information generated by the presentation information generation unit 114 based on the distance between the information processing apparatus 10 and the marker is displayed with the lower left position of the marker area 306 serving as an origin. However, the origin is not limited to that position, and the method of setting the origin is not limited in particular.

FIG. 3D and FIG. 3E are illustrations of projection results in the real world by the information processing apparatus 10. The marker ID of the marker 303 illustrated in FIG. 3D is S1 LC204_240BK. Aprojectable surface 304 is a range being projected by the information processing apparatus 10. In FIG. 3D, the distance between the marker 303 and the information processing apparatus 10 is 2 m. Therefore, the information processing apparatus 10 projects the presentation information 305 containing two values, as illustrated in FIG. 3B. In FIG. 3E, because the distance between the marker 303 and the information processing apparatus 10 is 1 m, the information processing apparatus 10 projects presentation information 307 containing all the values, as illustrated in FIG. 3C.

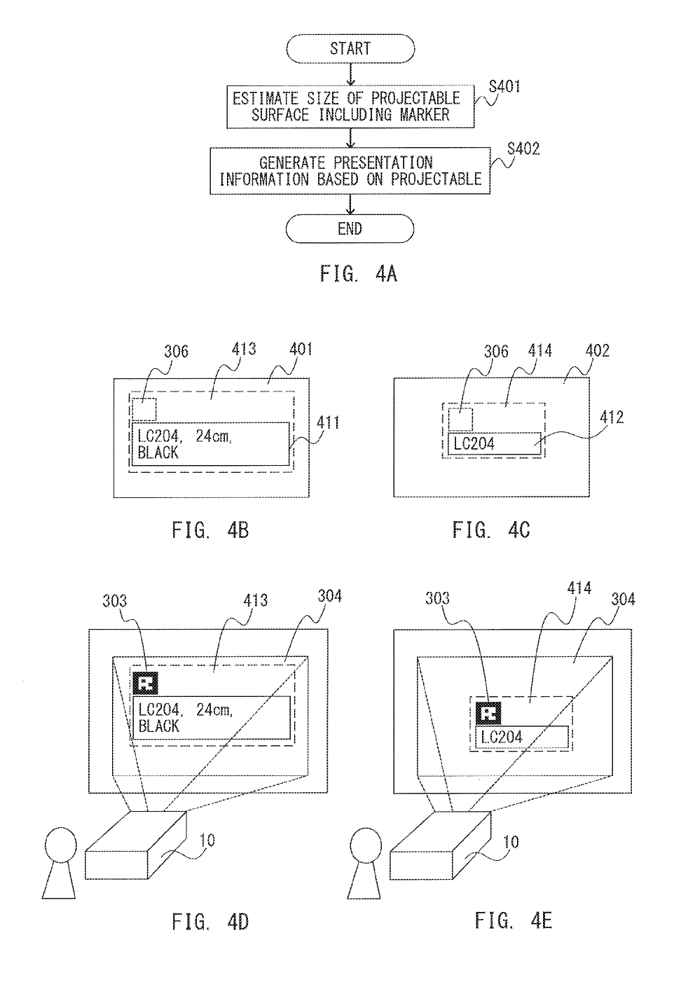

FIG. 4A is a flowchart for illustrating processing different from the processing of FIG. 2B regarding the processing for generating the presentation information on a single marker illustrated in Step S206 of FIG. 2A.

The projection environment estimation unit 113 estimates the size of the projectable surface based on the captured image (Step S401). For example, the projectable surface may be set as an area surrounded by a plurality of markers, or as an area surrounding the marker. In particular, an area that is near the marker and that the presentation information can be viewed from may be set as the projectable surface. In this example, the projectable surface is determined by utilizing a color gradient of the projection image. The projection environment estimation unit 113 recognizes the color gradient from the captured image, and projects a projection image in which the projectable surface is an area that is adjacent to the marker and that has a color gradient of a predetermined value or less. The reason for projecting the projection image in this manner is because the projection image is more difficult to view when the color gradient is large, but is easier to view when the color gradient is small. The presentation information generation unit 114 generates the presentation information in accordance with the related information corresponding to the marker, the projectable surface surrounding the marker, and the position of the marker (Step S402), and then ends the processing.

FIG. 4B is an illustration of a projection image 401 generated by the presentation information generation unit 114 based on the related information shown in FIG. 3A. In FIG. 4B, presentation information 411 is the information for a case in which the projectable surface has a surface area of 60,000 square pixels, and three values for three of the items among the related information, namely, “LC204, 24 cm, black”, are stored. A projectable surface 413 represents the projectable surface in the projection image 401. FIG. 4C is an illustration of a projection image 402 generated by the presentation information generation unit 114 based on the related information shown in FIG. 3A. In FIG. 4C, a case in which the projectable surface is smaller than that in FIG. 4B is illustrated. Presentation information 412 is the information for a case in which the projectable surface has a surface area of 25,000 square pixels, and only one value among the related information, namely, “LC204”, is stored. A projectable surface 414 represents the projectable surface in the projection image 402.

An example of a method of generating the presentation information in accordance with the projectable surface is now described. First, the projection environment estimation unit 113 calculates the surface area of the projectable surface to be included in the video. In this embodiment, the surface area of the projectable surface is calculated in units of square pixels. Next, the presentation information generation unit 114 includes in the presentation information related information in an amount that fits within the surface area of the projectable surface. In this embodiment, with the lower left position of the marker area 306 serving as the origin, the presentation information generation unit 114 displays pieces of presentation information 411 and 412.

FIG. 4D is an illustration of a result of the presentation information illustrated in FIG. 4B projected by the information processing apparatus 10. Similarly, FIG. 4E is an illustration of a result of the presentation information illustrated in FIG. 4C projected by the information processing apparatus 10. In FIG. 4D and FIG. 4E, the projectable surface 413 and the projectable surface 414 represent the areas estimated by the projection environment estimation unit 113 to be the projectable surface. In FIG. 4D, because the surface area of the projectable surface 413 is 60,000 square pixels, the information processing apparatus 10 projects the presentation information 411. In FIG. 4E, because the surface area of the projectable surface 414 is 25,000 square pixels, the information processing apparatus 10 projects the presentation information 412.

In Step S212 of FIG. 2B, the distance to the marker is calculated by utilizing the size of the marker appearing in the captured image. However, the distance between the information processing apparatus 10 and the marker may calculated by an arbitrary method. For example, the distance may be estimated by using a distance sensor that utilizes ultrasonic waves or infrared rays, for example. Use of a distance sensor enables the distance to the marker to be estimated even when the size of the marker is not known in advance. Further, when using an optical projection unit, e.g., the projector 106, and an optical image capture unit, e.g., the camera 105, like in this embodiment, the distance to the marker may be estimated based on the focal lengths of those units. In this case, the user adjusts the focal length and the distance to the marker so that the focus of the projector 106 or of the camera 105 is on the marker. As a result, the focus of the projector 106 and of the camera 105 can be presumed to be on the marker. Therefore, the in-focus distance can be estimated based on the current focal length, and that value can be used for the distance. Estimation of the distance to the marker based on the focal length enables the distance to the marker to be estimated even when the size of the marker is not known in advance.

In Step S213 of FIG. 2B and Step S402 of FIG. 4A, the presentation information generation unit 114 may generate the presentation information in accordance with an f-number of the projector 106. As an example, when the f-number is at a minimum, namely, when a diaphragm in the projector 106 is opened to a maximum level, the presentation information generation unit 114 may reduce the amount of information contained in the related information, and increase the size of the information to be displayed by that reduction amount. As the increasing level of opening of the diaphragm in the projector 106, the brightness of the projector 106 is increased and the contrast of the video is reduced. The fact that the diaphragm is opened to its maximum level by the user means that the projection video of the projector 106 is so difficult to see that it is necessary to increase the brightness of the projector 106 to its maximum level. As a result, enlargement of the characters and images to be displayed when the diaphragm is opened to its maximum level has an effect of improving visibility for the user.

In the example described above, the amount of information is reduced when the f-number is at a minimum. However, the amount of information may be reduced when the f-number is smaller than a predetermined value.

Further, the presentation information generation unit 114 may be configured to change a display mode of the presentation information when the f-number is at a minimum or is smaller than the predetermined value. In this case, it is preferred that the display mode be changed so as to improve the visibility of the presentation information. For example, the display mode may be changed by increasing the size of the characters, increasing the character spacing, or displaying an icon in place of displaying characters.

In Step S401 of FIG. 4A, the recognition unit 111 may acquire the size of the projectable surface corresponding to the recognized marker ID from the ROM 102, the HDD 104, or a database defined in a device external to the information processing apparatus 10. When the position of the information processing apparatus 10 and the position of the marker are known, storing of the position information on the information processing apparatus 10 and the marker in the ROM 102, for example, enables the position and the size of the projectable surface corresponding to each marker to be defined in advance.

The presentation information may be generated by various methods. The presentation information may be stored based on the size of the projectable surface in order of the information capable of fitting in the size of the projectable surface. In this case, the information requiring a smaller display surface area, e.g., information having a smaller number of characters, is preferentially stored in the presentation information. Further, a priority may be determined for each value contained in the related information, and the values may be included in the presentation information in descending order of priority.

When the values are stored in the presentation information in order of priority, a situation may occur in which a value having a large required display surface area (hereinafter referred to as “value A”) cannot be stored, but a value having a lower priority and a small required display surface area can be stored. In this case, the value A is not stored in the presentation information, and a determination is made as to whether or not the value having the next highest priority can be stored in the presentation information. The priority may be determined in advance, or may be specified by the user. In the embodiment described above, the presentation information is projected on a separate area from the marker. However, the position and the size may be determined so that the presentation information is projected superimposed on the marker. Further, the information may be projected in any one of the marker directions so that the information is not projected superimposed on the marker. When the color gradient of the marker is strong, visibility can be ensured by projecting the information so that the information is not projected superimposed on the marker.

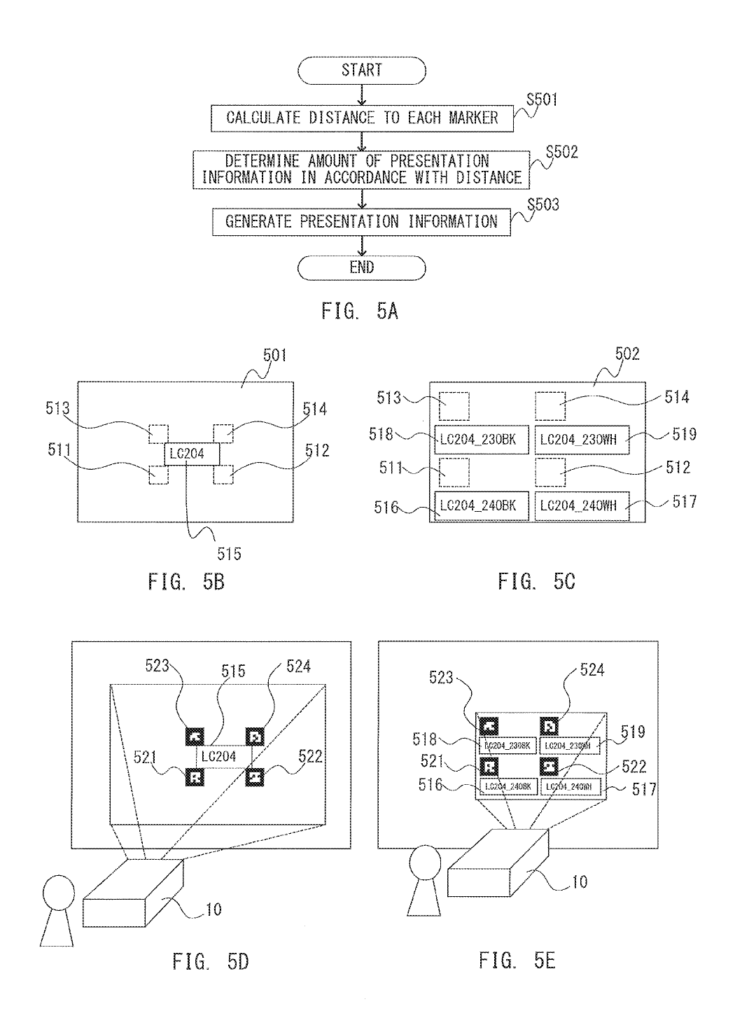

FIG. 5A is a flowchart for illustrating the processing for generating presentation information on a plurality of markers illustrated in Step S207 of FIG. 2A. The projection environment estimation unit 113 calculates, for all of the markers included in the captured image, the distance between each marker and the information processing apparatus 10 (Step S501). As the method of calculating the distance, similar to the processing in Step S211 and Step S212, a method of estimating the distance by using the size of each marker appearing in the captured image may be used. Further, a distance sensor or the focal lengths of the projector 106 and the camera 105 may be used.

Next, the presentation information generation unit 114 determines the amount of presentation information in accordance with the distance between the markers and the information processing apparatus 10 (Step S502). In particular, in this embodiment, as an example of processing for increasing or decreasing the amount of information, the number of pieces of presentation information to be generated is determined in accordance with the distance between the markers and the information processing apparatus 10. More specifically, the distance between the information processing apparatus 10 and the markers is calculated, and the number of pieces of presentation information is determined in accordance with the calculated value. In this case, the “number of pieces of presentation information” corresponds to the number of images to be arranged as independent partial areas in the projection image output from the projector 106.

For example, in the case of an application in which text information is arranged in a graphic object having a rectangular shape, a speech balloon shape, for example, and projection is performed so that the graphic object is not superimposed on the actual object, the number of graphic objects may be considered to be the number of pieces of presentation information. In this embodiment, when the distance between the markers and the information processing apparatus 10 is a predetermined value or more, a total of one piece of presentation information for the plurality of markers is generated, and when that distance is less than the predetermined value, the same number of pieces of presentation information as the number of recognized markers is generated. In this example, the amount of information to be included in one piece of presentation information is roughly constant. Therefore, when the same number of pieces of presentation information as the number of markers is generated, the amount of projectable information is more than when only one piece of presentation information is generated. When the distance between the information processing apparatus 10 and each marker is different, the average of those distances is taken as the distance between the information processing apparatus 10 and the markers. In the following description, the predetermined value is 1.5 m.

Next, the presentation information generation unit 114 generates the presentation information based on the amount of information determined in Step S502 (Step S503). In this embodiment, the determined number of pieces of presentation information is generated. FIG. 5B is an illustration of an example of the presentation information generated in a projection image 501 by the presentation information generation unit 114 in Step S503 of FIG. 5A based on the related information shown in FIG. 3A. In FIG. 5B, an area 511 represents the position and the size in the projection image 501 of the marker having the marker ID S1_LC204_240BK, and an area 512 represents the position and the size in the projection image 501 of the marker having a marker ID S1_LC204_240WH.

An area 513 represents the position and the size in the projection image 501 of the marker having a marker ID S1_LC204_230BK. Presentation information 515 represents the presentation information generated by the presentation information generation unit 114 when the distance between the information processing apparatus 10 and the markers is 2 m. In this example, when the distance is 2 m, the presentation information generation unit 114 determines in Step S502 that one piece of presentation information is to be generated.

In FIG. 5C, pieces of presentation information 516, 517, 518, and 519 generated by the presentation information generation unit 114 in a projection image 502 when the distance between the information processing apparatus 10 and the markers is 1 m are illustrated. Because the distance between the information processing apparatus 10 and the markers is less than 1.5 m, the same number of pieces of presentation information as the number of recognized markers is generated. The marker IDs of the generated pieces of presentation information 516 and 517 are respectively S1_LC204_240BK and S1_LC204_240WH. The marker IDs of the generated pieces of presentation information 518 and 519 are respectively S1_LC204_230BK and S1_LC204_230BK.

The presentation information generation unit 114 generates, when generating a plurality of pieces of presentation information, the presentation information so that the content of each piece of presentation information is different. Specifically, among the pieces of related information corresponding to each marker, a piece of information having a different value for all of the marker IDs is preferentially included in the presentation information.

As shown in FIG. 3A, the product name in each of the marker IDs is shared, namely, is LC204. Further, the values for the size and the color are shared by some of the markers. For example, in the marker IDs S1_LC204_240BK and S1_LC204_240WH, in both cases the color is black, which is the same. On the other hand, in all of the marker IDs, the values for the product ID and the image are different. Therefore, the pieces of presentation information 516, 517, 518, and 519 are included in the presentation information by prioritizing the product ID.

In FIG. 5D and FIG. 5E, projection results by the information processing apparatus 10 are illustrated. The marker IDs of markers 521 and 522 are S1_LC204_240BK and S1_LC204_240WH. The marker IDs of markers 523 and 524 are S1_LC204_230BK and S1_LC204_230WH.

In FIG. 5D, the distance between each of the markers 521, 522, 523, and 524 and the information processing apparatus 10 is 2 m, which is 1.5 m or more. Therefore, the information processing apparatus 10 projects the presentation information 515.

In FIG. 5E, the distance between each of the markers 521, 522, 523, and 524 and the information processing apparatus 10 is 1 m, which is less than 1.5 m. Therefore, the information processing apparatus 10 projects the pieces of presentation information 516, 517, 518, and 519.

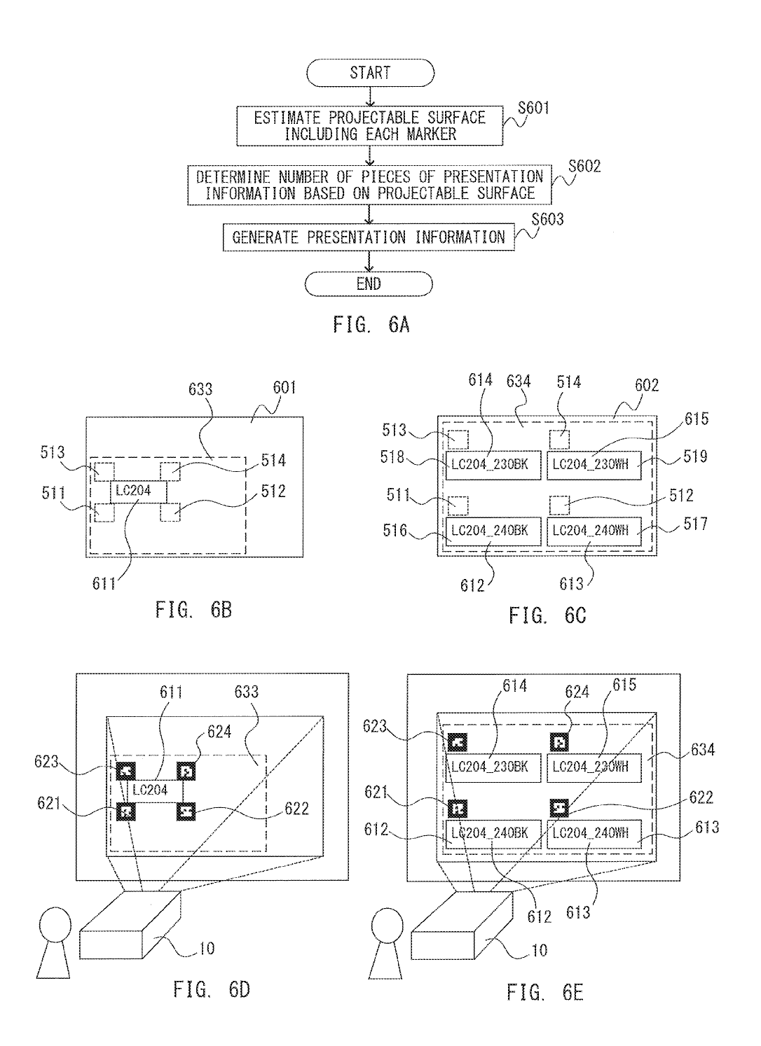

FIG. 6A is a flowchart for illustrating processing different from the processing of FIG. 5A regarding the processing for generating the presentation information on a plurality of markers illustrated in Step S207 of FIG. 2A.

The presentation information generation unit 114 estimates, for all of the markers included in the captured image, the projectable surface including the markers (Step S601). The projectable surface may be estimated by, similar to the processing in Step S401 of FIG. 4A, calculation based on the color gradient of the captured image, or by issuing an inquiry to an external device about the projectable surface for the recognized marker IDs.

Next, the presentation information generation unit 114 determines the number of pieces of presentation information to be generated based on the size of the projectable surface of each marker (Step S602). An example of the method of determining the number of pieces of presentation information is a method in which the number of pieces of presentation information is determined in accordance with a total value of the surface area of the projectable surface. In this embodiment, when the surface area of the projectable surface is less than 50,000 square pixels, one piece of presentation information is generated, and when the surface area of the projectable surface is 50,000 square pixels or more, the same number of pieces of presentation information as the number of recognized markers is generated. Next, the presentation information generation unit 114 generates as many pieces of presentation information as the number determined in Step S602 (Step S603).

FIG. 6B and FIG. 6C are illustrations of examples of the presentation information generated in Step S603 of FIG. 6A by the presentation information generation unit 114 based on the related information shown in FIG. 3A. In FIG. 6B, presentation information 611 arranged in a projection image 601 is the presentation information generated by the presentation information generation unit 114 when the surface area of the projectable surface is 25,000 square pixels. Because the surface area of the projectable surface is less than 50,000 square pixels, in the example illustrated in FIG. 6B, only one piece of presentation information 611 is projected.

In FIG. 6C, pieces of presentation information 612, 613, 614, and 615 arranged in a projection image 602 are pieces of presentation information generated by the presentation information generation unit 114 when the surface area of a projectable surface is 60,000 square pixels. Because the surface area of the projectable surface is 50,000 or more square pixels, in the example illustrated in FIG. 6C, four pieces of presentation information are generated, which is the same number as the number of markers. The pieces of presentation information 612 and 613 are pieces of presentation information corresponding to the markers having the marker IDs S1_LC204_240BK and S1_LC204_240WH. The pieces of presentation information 614 and 615 are pieces of presentation information corresponding to the markers having the marker IDs S1_LC204_230BK and S1_LC204_230W.

In FIG. 6D and FIG. 6E, projection results by the information processing apparatus 10 are illustrated. In FIG. 6D, the total surface area of a projectable surface 633 including markers 621, 622, 623, and 624 is 25,000 square pixels . Therefore, the information processing apparatus 10 projects the presentation information 611. In FIG. 6E, the total surface area of a projectable surface 634 including the markers 621, 622, 623, and 624 is 60,000 square pixels. Therefore, the information processing apparatus 10 projects the pieces of presentation information 612, 613, 614, and 615.

In the examples of FIG. 5A to FIG. 5E and FIG. 6A, to FIG. 6E, a case is illustrated in which all the markers are included in one projectable surface, and when the surface area of the projectable surface is less than 50,000 square pixels, one piece of presentation information is projected on one projectable surface.

However, depending on the color of the projection surface, there may be a case in which an area including a given marker and an area including another marker are not contiguous in the projectable surface. An example of such a case is when a plurality of areas having a small color gradient are split by an area having a large color gradient.

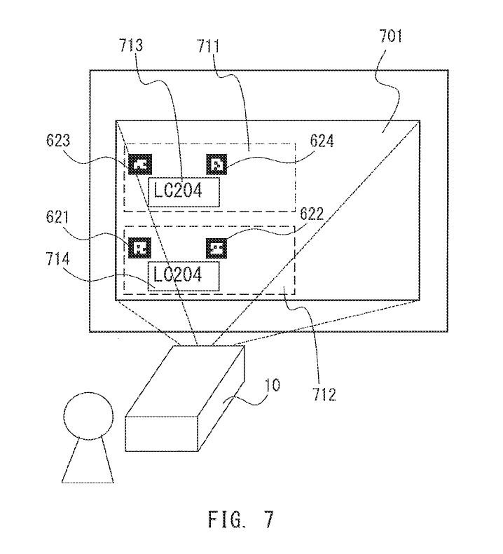

In such a case, when presentation information that straddles a plurality of areas in one projectable surface is projected, visibility may decrease due to a difference in the color gradient, for example. Therefore, in the example illustrated in FIG. 7, the presentation information generation unit 114 has divided one projectable surface into various split areas. In the following description, an area divided in such a manner is referred to as a divided surface. One piece of presentation information is generated for one or a plurality of markers included in each divided surface. The details of this are described below.

FIG. 7 is an illustration of an example of a projection image when the number of pieces of presentation information projected in the projectable surface is determined to be “1” in Step S602 of FIG. 6A, and one value is included in each piece of presentation information. As illustrated in FIG. 7, the recognition unit 111 recognizes the four markers 621, 622, 623, and 624 in a projection image 701.

In this example, because an area having a large color gradient is present in the projectable surface, the projectable surface is divided by the presentation information generation unit 114 into a first divided surface 711 and a second divided surface 712. The markers 623 and 624 are included in the divided surface 711. The markers 621 and 622 are included in the second divided surface 712, which is in a separate area that is not contiguous to the divided surface 711.

As described above, in Step S602, the number of pieces of presentation information to be generated in the projectable surface is determined to be one. However, the presentation information generation unit 114 generates one piece of presentation information for each of the divided surface 711 and the second divided surface 712. As a result, two pieces of presentation information are projected on the pre-divided projectable surface.

As illustrated in FIG. 7, presentation information 713 is projected on the divided surface 711 and presentation information 714 is projected on the second divided surface 712. As a result, a decrease in the visibility due to presentation information being projected on an area having a large color gradient can be prevented.

Thus, a suitable amount of presentation information in accordance with the projection environment may be projected by changing the content and the number of pieces of presentation information in accordance with the distance between the information processing apparatus 10 and the markers, and the surface area and the shape of the projectable surface.

In Step S502 and Step S602, the presentation information generation unit 114 may determine the number of pieces of presentation information in accordance with the f-number of the projector 106. As an example, when the f-number is opened to a maximum level, the presentation information generation unit 114 may reduce the number of pieces of presentation information, and increase the size of the characters and the images to be displayed by that reduction amount. The fact that the user is opening the diaphragm to its maximum level means that the projection video of the projector 106 is so difficult to see that it is necessary to increase the brightness of the projector 106 to its maximum level. As a result, reducing of the number of pieces of presentation information when the diaphragm is opened to its maximum level and increasing of the size of the characters and images to be displayed by that reduction amount has an effect of improving visibility for the user. In place of reducing the number of pieces of presentation information, the display mode of the presentation information may also be changed by increasing the visibility of the presentation information.

In this embodiment, a projector is used as an example of the image display unit. However, the present invention is not limited to this, and may use any display device capable of displaying a live view image, such as a head-mounted display, a smartphone, and a tablet computer. The term “distance” when using a projector as the image display unit refers to the distance from the information processing apparatus to the projection surface. On the other hand, because the concept of a projection surface does not apply when using a display device as the image display unit, the term “distance” refers to the distance from the information processing apparatus to the target object.

When a display device is used as the image display unit, information can also be displayed on a position different from the target object. For example, information can be displayed even in a space surrounding the target object.

Information may also be displayed by a method different from that in this embodiment. For example, information may be displayed in a place that is not on the target object. However, when there are a plurality of target objects arranged across the entire screen, and there is no room to display information other than on the target objects, it is difficult to display information on a place that is not on a target object. In this case, an effect of improving visibility for the user can be obtained by the method according to this embodiment. Further, in this embodiment, a case is described in which the recognition unit 111 is configured to recognize the markers. However, the recognition unit 111 may use bodies other than a marker for recognition. For example, the recognition unit 111 may be configured to recognize objects, and not markers. In this case, the recognition unit 111 is configured to identify an object ID by recognizing the shape of the object. Therefore, the target object itself is recognized as a marker.

A known technology is utilized to recognize the shape of the object. An example of a simple method is to prepare an image obtained in advance by capturing the shape of the object from a plurality of angles, and perform partial matching with the captured image. It is also effective to prepare the shape of the object as a 3D model, and perform matching with a range image (in this case, a device capable of range acquisition, e.g., a range image sensor or a stereo camera, is necessary).

### Second Embodiment

In the first embodiment, when there are a plurality of markers in a captured image, an example in which one piece of presentation information is generated for each of the plurality of markers and an example in which only one piece of presentation information is generated are described. When one piece of presentation information is generated for each marker, the pieces of presentation information and the markers correspond to each other on a “one-to-one basis”, and the relation between the pieces of presentation information and the markers is clear. When only one piece of presentation information is generated, it is clear that that piece of presentation information corresponds to all of the markers on a “1:all” basis. Therefore, in those examples, the correspondence relation between the markers and the pieces of presentation information is clear.

The number of pieces of presentation information is not limited to this. For example, the number of pieces of presentation information may be an arbitrary number of from two or more to less than the number of markers. Increasing or decreasing of the number of pieces of presentation information in that range allows the amount of information to be finely adjusted in accordance with the projection environment, and visibility to be improved. However, in this case, there are a plurality of pieces of presentation information and a plurality of markers, and hence the correspondence relation between the pieces of presentation information and the markers is not clear.

In a second embodiment of the present invention, a method is described for a case in which, when the relation between the markers and the pieces of presentation information is not clear, the positions of the pieces of presentation information are determined so as to clarify the relation between the markers and the pieces of presentation information. In this embodiment, a plurality of markers are grouped into N-number of marker groups each including one or more markers, and one piece of presentation information is associated with each marker group. N is a number of from two or more to less than the number of markers.

Because there may be cases in which there are a plurality of combinations of the markers to be included in the marker groups, among the plurality of combinations, it is desired that a combination that increases visibility be selected. Therefore, in this embodiment, combinations are selected in which, among the markers to be included in the marker groups, markers having a high similarity degree are arranged in the same marker group, and markers having a low similarity degree are arranged in different marker groups. Specifically, the similarity degree among the markers forming each marker group is calculated, and the combination of the markers to be included in each marker group is determined by using each similarity degree.

When the distances among the markers to be included in one marker group are far apart, regardless of where the presentation information is displayed, the presentation information is displayed at a position far away from at least one of the markers. As a result, it is difficult for the user to identify the markers corresponding to the presentation information. Therefore, in this embodiment, the information processing apparatus 10 is configured to perform processing for calculating the distances among the markers forming the marker groups, and determining the combination of the markers to be included in each marker group by using the distance calculated for each marker group. As described above, the target objects themselves may also be used as markers. In this case, the distances among the target objects are calculated, and the combinations of the target objects to be included in target object groups are determined.

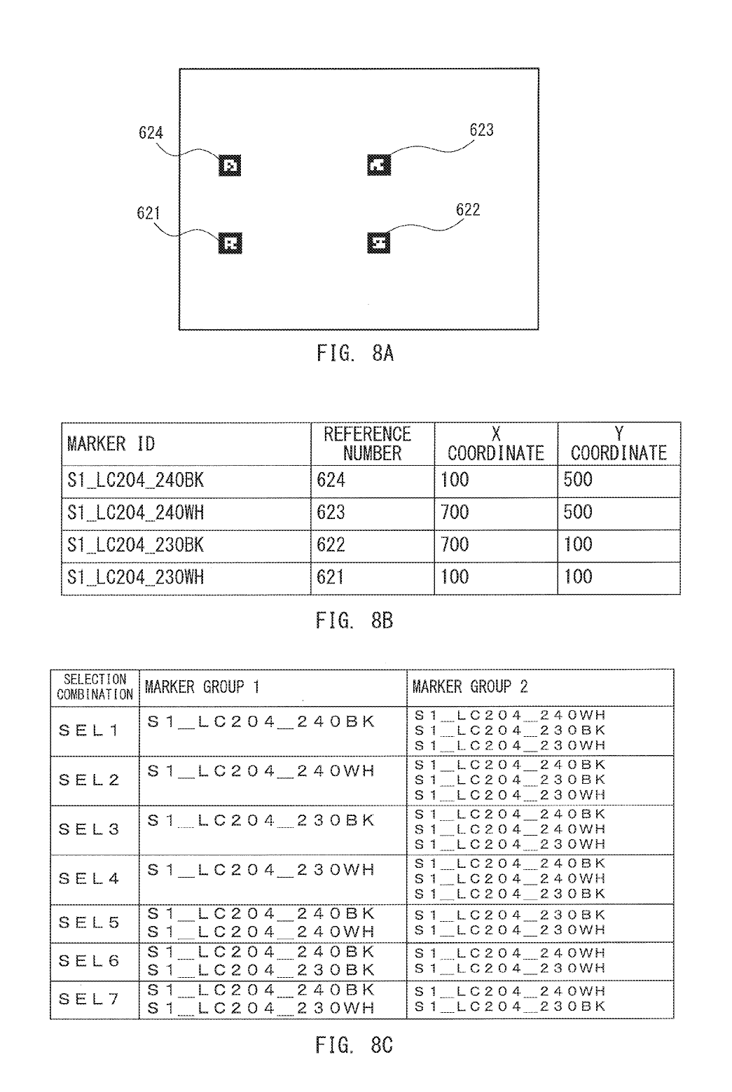

In FIG. 8A, four markers included in an image captured by the camera 105 are illustrated. As illustrated in FIG. 8A, in this example, the markers 621, 622, 623, and 624 are included in the captured image. FIG. 8B is a table for showing the IDs and the positions in the image of the four markers included in the captured image illustrated in FIG. 8A. FIG. 8C is a table for showing all the combinations of how the markers may be selected for the marker groups when the number of markers is four and two marker groups are to be generated. However, one or more markers are always allocated to one marker group.

As illustrated in FIG. 8A, in this example, there are four markers, and the four markers are allocated to two marker groups.

As shown in FIG. 8B, the position of each marker is specified by a horizontal direction in FIG. 8A as an x-axis and a vertical direction in FIG. 8A as a y-axis, with the lower left of the screen in the projection image serving as the origin. For example, the marker having the marker ID S1_LC204_230WH corresponds to the marker 621 positioned at a position (100,100), which is positioned in the lower left in FIG. 8A. Similarly, the marker having the marker ID S1_LC204_240BK corresponds to the marker 624 at a position (100,150), the marker having the marker ID S1_LC204_240WH corresponds to the marker 623 at a position (700,500), and the marker having the marker ID S1_LC204_230BK corresponds to the marker 622 at a position (700,100).

As shown in FIG. 8C, in general, there are two ways of allocating the markers. One way is to allocate one marker to one marker group and three markers to another marker group (SELs 1 to 4), and another way is allocate two markers to both the marker groups (SELs 5 to 7).

SELs 1 to 4 indicate the results of selecting one marker from among the four markers, and allocating the selected marker to a marker group 1 and the remaining three markers to a marker group 2. SELs 5 to 7 show the results of selecting two markers from among the four markers, and allocating the selected markers to the marker group 1 and the remaining two markers to the marker group 2. As shown in FIG. 8C, one or more markers is/are always allocated to one marker group. Therefore, when allocating four markers to two marker groups, there are seven combinations.

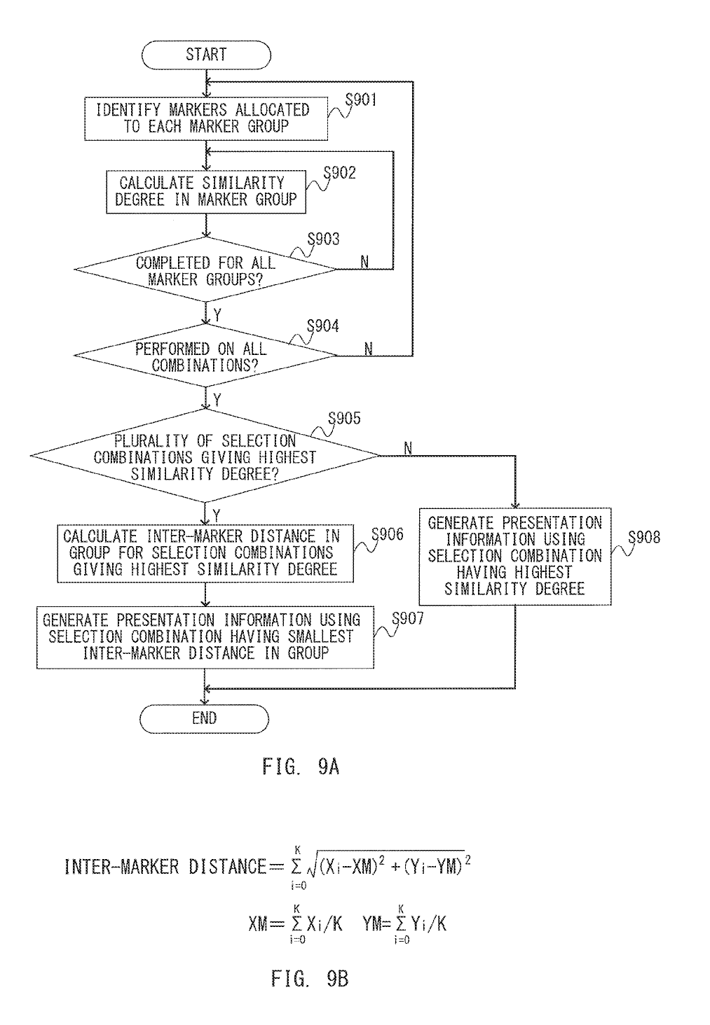

FIG. 9A is a flowchart for illustrating processing for determining which combination is to be employed among the marker group combinations shown in FIG. 8C.

The presentation information generation unit 114 identifies the markers allocated to each marker group for each combination of the marker groups (Step S901). For example, for the SEL 1 shown in FIG. 8C, the markers allocated to each of the marker group 1 and the marker group 2 are identified. As a result, the marker having the marker ID S1_LC204_240BK is allocated to the marker group 1, and the remaining three markers are allocated to the marker group 2.

Next, the presentation information generation unit 114 calculates the similarity degree among the markers included in each of the marker groups (Step S902). In this embodiment, as a method of calculating the similarity degree, the similarity degree of the related information corresponding to each marker is utilized. The similarity degree may be defined by an arbitrary method. However, in this embodiment, the similarity degree is defined based on the number of pieces of related information that have the same value for all of the markers included in the group. When the number of pieces of related information having the same value is larger, the similarity degree is determined to be higher. When the number of markers included in a group is one, the similarity degree is taken to be zero.

Therefore, for example, for the SEL 1 shown in FIG. 8C, because the number of markers included in the marker group 1 is one, the similarity degree is zero. For the marker group 2, as shown in FIG. 8C, among the pieces of related information, only the value of the product name (LC204) is shared by all the markers, and all the other values are different. Therefore, the similarity degree is one.

The presentation information generation unit 114 determines whether or not the processing of Step S902 is complete for all the marker groups (Step S903). When the processing is not complete (Step S903: N), the processing of Step S902 is executed again. When the processing is complete (Step S903: Y), the presentation information generation unit 114 determines whether or not the processing is complete for all the selection combinations of the marker groups (Step S904). In the example shown in FIG. 8C, the presentation information generation unit 114 determines whether or not processing is complete for all the SELs 1 to 7. When the processing is not complete (Step S904: N), the processing of Step S901 is executed again. When the processing is complete (Step S904: Y), the presentation information generation unit 114 calculates, for each selection combination, the total similarity degree of each marker group, and determines whether or not there are a plurality of selection combinations for which that total is the highest (Step S905). In the example shown in FIG. 8C, the presentation information generation unit 114 calculates, for the SELs 1 to 7, the total similarity degree of each marker group, and determines whether or not there is one selection combination that gives the highest total similarity degree.

When there is only one selection combination that gives the highest total similarity degree (Step S905: N), the presentation information is generated by using that selection combination (Step S908). When there are a plurality of selection combinations that give the highest total similarity degree (Step S905: Y), the presentation information generation unit 114 calculates the inter-marker distance in the marker group for those selection combinations (Step S906).

In this embodiment, the inter-marker distance in the marker group is calculated based on the expression illustrated in FIG. 9B. In the expression, K represents the number of markers included in the marker group, X0, X1, Xi, and XK represent the position of each marker in the X-direction in the captured image, and Y0, Y1, Yi, and YK represent the position of each marker in the Y-direction in the captured image.

The presentation information generation unit 114 generates the presentation information by using the selection combination giving the smallest total inter-marker distance in the group among the selection combinations of the groups giving the highest similarity degree (Step S907), and then ends the processing.

The processing for determining which selection combination is to be used to generate the presentation information among the selection combinations of the marker groups shown in FIG. 8C is now described in more detail with reference to FIG. 9A.

First, the presentation information generation unit 114 executes the processing of Step S902 on the two marker groups included in the selection combination SEL 1. Because only one marker is included in the marker group 1 of SEL 1, the similarity degree is zero, and because the shared value for the markers included in the marker group 2 is the product name LC204, the similarity degree is one. As a result, the similarity degree of the SEL 1 is obtained by adding the similarity degree of the marker group 1 and the similarity degree of the marker group 2, to give a total of one. Similarly, the similarity degrees of the SEL 2, the SEL 3, and the SEL 4 are also all one.

On the other hand, for the SEL 5, in the marker group 1, because the LC204 and the size of 23 cm match in the related information, the similarity degree is two. In the marker group 2 as well, the product name and the size match in the related information, and hence the similarity degree is two. Therefore, the total similarity degree is 4.

For the SEL 6, in the marker group 1, the size in the related information is different, but the color matches, and hence the similarity degree is two. Similarly, the similarity degree for the marker group 2 is two. Therefore, the total similarity degree is four.

For the SEL 7, in both the marker group 1 and the marker group 2, only the product name matches in the related information, and hence the similarity degree for each marker group is one. Therefore, the total similarity degree is two.

Thus, in Steps S905, the presentation information generation unit 114 determines that there are two selection combinations giving the highest similarity degree, namely, the SEL 5 and the SEL 6. Next, in Step S906, the presentation information generation unit 114 calculates the inter-marker distance in the marker group for each marker group included in the SEL 5 and the SEL 6.

In the calculation expression of FIG. 9B, XM represents an average value for the X coordinates of the markers in the marker group. In the marker group 1 of the SEL 5, because the X coordinate of the marker 624 is 100 and the X coordinate of the marker 623 is 700, XM is 400. Regarding the Y coordinates, because the Y coordinates of those markers are both 500, YM is also 500.

Next, based on the positions of the markers shown in FIG. 8B and the calculation expression of FIG. 9B, the inter-marker distance of the marker group 1 of the SEL 5 is calculated. The value is calculated to be [√{(100−400)²+(500−500)²}+√{(700−400)²+(500−500)²}], namely, to be 600.

The inter-marker distance of the marker group 2 of the SEL 5 is also calculated to be 600 (XM=400, YM=100). As a result, the total inter-marker distance in the marker group of the marker groups included in the SEL 5 is 1,200.

Next, the inter-marker distance of the marker group 1 of the SEL 6 is calculated to be about 721 (XM=400, YM=300). Further, the inter-marker distance of the marker group 2 of the SEL 6 is calculated to be about 721 (XM=400, YM=300). As a result, the total inter-marker distance in the marker group of the marker groups included in the SEL 6 is 1,442. Therefore, in Step S907, the presentation information generation unit 114 determines that the presentation information is to be generated based on the SEL 5, which has the smallest inter-marker distance in the marker group. Further, the presentation information generation unit 114 projects the presentation information for the marker group 1, which includes the marker 623 and the marker 624, and projects the presentation information for the marker group 2, which includes the marker 621 and the marker 622.

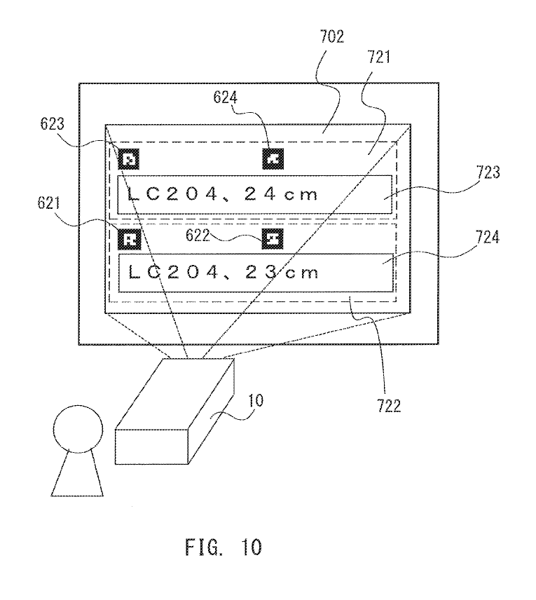

In FIG. 10, how the presentation information generated by the information processing apparatus 10 as a result of the processing described above is projected is illustrated. In FIG. 10, the four markers 621, 622, 623, and 624 are shown in a projection image 702.

As illustrated in FIG. 10, the projection image 702 is divided into a first divided surface 721 and a second divided surface 722 as a result of the presentation information being generated based on the SEL 5. Presentation information 723 is projected for the two markers 623 and 624. As the values of the presentation information 723, “LC204” and “24 cm” are projected.

Presentation information 724 is projected for the two markers 621 and 622. As the values of the presentation information 723, “LC204” and “23 cm” are projected. As a result, marker groups including markers having a high similarity degree can be generated, and presentation information can be presented for each marker group. Further, the correspondence relation between the markers and the presentation information is clearer.

Thus, determination of the selection combinations of the marker groups based on the related information on the markers and the positions of the markers included in the captured image enables presentation information to be presented for marker groups that have a high similarity degree in content and that are close to each other.

In FIG. 8A to FIG. 8C, FIG. 9A, FIG. 9B, and FIG. 10, a case is described in which a plurality of markers are grouped, and information is presented for each group. It is presumed that in the processing all the markers are classified into any one of the groups. However, the present invention is not limited to this. The information processing apparatus 10 may be configured to not classify a given marker into any one of the groups, and to not present information on that group. Similarly, the information processing apparatus 10 may be configured to not present information for a given group.

For example, the information processing apparatus 10 may be configured to present information on M-number (M is a number determined in advance) of higher-level groups having a higher priority based on a priority determined in advance. When the number of groups is larger than M, information on several of the groups having a lower priority is not presented.

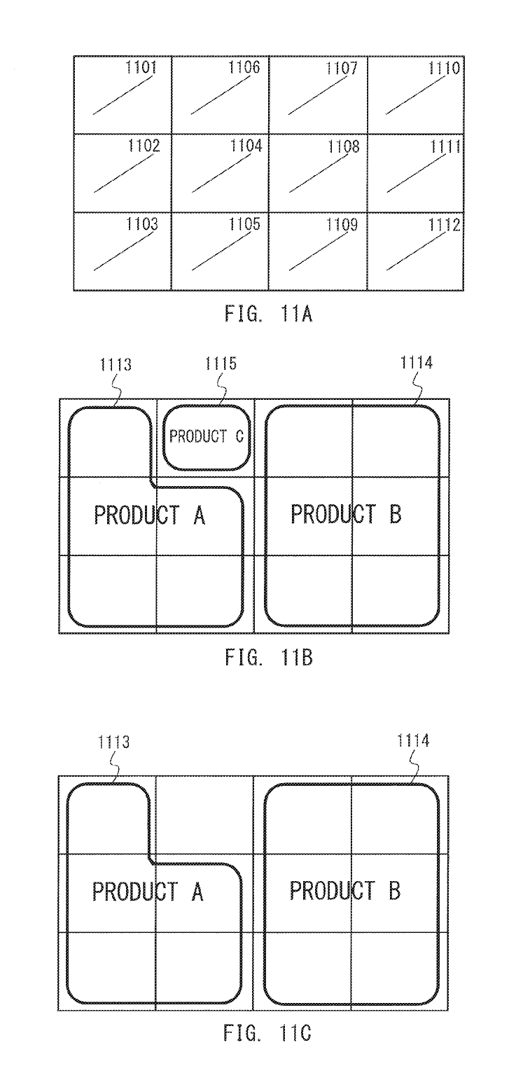

FIG. 11A to FIG. 11C are schematic diagrams for illustrating information presentation examples of groups when M=2. In FIG. 11A, boxes 1101 to 1112, each of which contains a product, are arranged in three columns vertically and four rows horizontally. The boxes 1101 to 1105 each contain a product A, the box 1106 contains a product C, and the boxes 1107 to 1112 each contain a product B. A marker is attached to each of the product boxes. However, in order to simplify the description, those markers are not shown. FIG. 11B is an illustration of a result of a case in which the product boxes illustrated in FIG. 11A are grouped, and the number of pieces of information to be presented is not limited. In FIG. 11B, presentation information 1113 is presentation information for a group of the product A. In this example, the information is presented by the characters “Product A” and a thick, black, and solid line surrounding the target product.

Similarly, presentation information 1114 is presentation information on the product B and presentation information 1115 is presentation information on the product C. For example, in this store, a focus is placed on the sale of the product A and the product B, and hence the priorities are set as “product A >product B >product C”, and the number of pieces of information to be presented is set to M=2. In FIG. 11C, a result of information presentation in such a case is illustrated. Because M=2, information only on the product A and the product B is presented. Therefore, it is easier for the customer using the information processing apparatus 10 to focus on the product A and the product B.

As another embodiment, the priority of a product that is a short distance from the center of projection may be set higher. In this case, group information is presented in order of closeness to the center of projection. As yet another embodiment, the number of pieces of information to be presented may be determined in advance, or the number may be determined in accordance with the size of the projectable area.

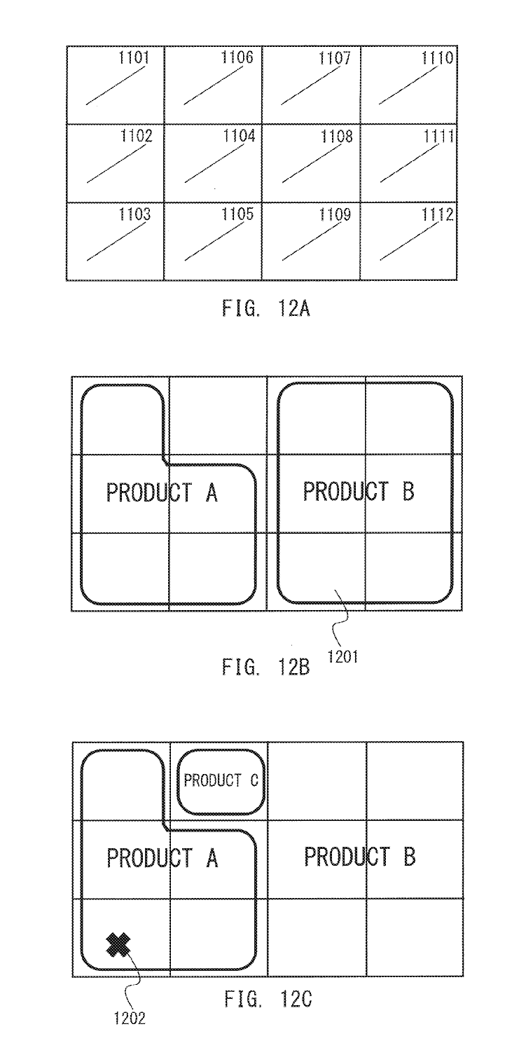

FIG. 12A to FIG. 12C are explanatory diagrams of projection results when information on two groups (M=2) close to the center of projection is presented by setting the priorities of products that are a short distance from the center of projection to be high.

In FIG. 12A, similar to FIG. 11A, each of the boxes 1101 to 1112 contains a product. The boxes 1101 to 1105 each contain the product A, the box 1106 contains the product C, and the boxes 1107 to 1112 each contain the product B.

FIG. 12B is an illustration of a projection result for a case in which, among the boxes containing the product B, a center of projection 1201 is near the box 1109, which is positioned close to the product A. Because M=2, among the three products A to C, information on two groups, namely, the group of the product B and the group of the product A close to the center of projection 1201, is presented. Therefore, information on the group of the product C is not presented.

FIG. 12C is an illustration of a projection result for a case in which a center of projection 1202 is near the box 1103, which contains the product A. The distance between the product C and the center of projection 1202 is shorter than the distance between the product B and the center of projection 1202. Therefore, information on two groups, namely, the group of the product B and the group of the product C, is presented, and information on the group of the product B is not presented. As a result, information on a place near that indicated by the user by using the information processing apparatus 10 is preferentially presented, and hence the visibility of the product information on the place the user wishes to focus on is improved. In FIG. 8A to FIG. 8C and FIG. 10, a case is illustrated in which information is presented by grouping a plurality of markers in groups in which the markers share at least a part of the related information.

However, the present invention is not limited to this. Markers having related information that does not match may also be present in the groups. Therefore, a group may be formed that includes a marker having related information that does not match, and information on that group may be presented.

For example, when the user wishes to view the overall projection image from overhead from a distance, there may be a case in which there is a need to present information that permits a slight level of information error and gives priority to visibility. In this case, through forming a group that includes a marker having related information that does not match, there is an advantage in that the user can more easily schematically grasp the overall projection image.

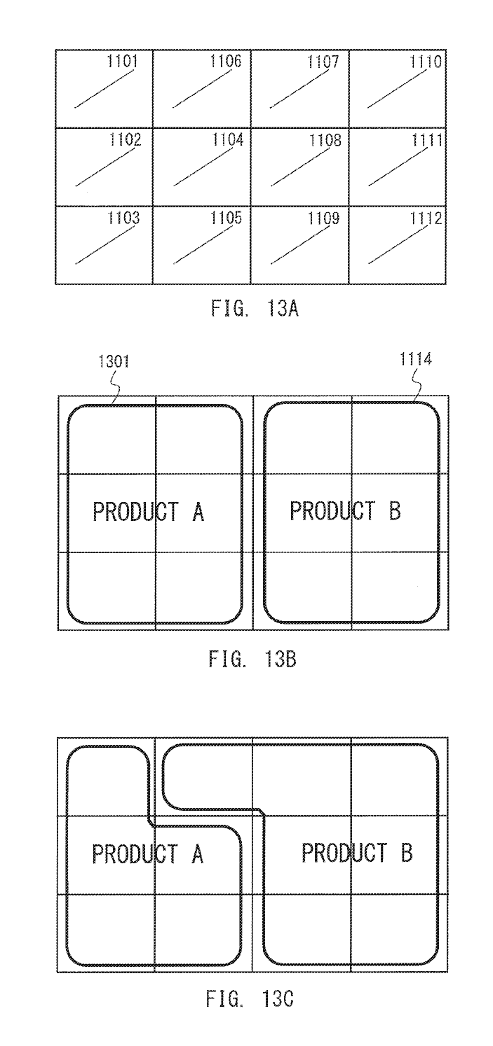

FIG. 13A to FIG. 13C are explanatory diagrams of an example of displaying the results of rough grouping in which markers having item values that do match are allowed to be included in the group. In this example, the number of products belonging to a given marker is less than two are caused to belong to another group, and are not formed as an independent group.

In FIG. 13A, similar to FIG. 11A, each of the boxes 1101 to 1112 contains a product . The boxes 1101 to 1105 each contain the product A, the box 1106 contains the product C, and the boxes 1107 to 1112 each contain the product B. In FIG. 13B, the result of information presentation in this example is illustrated. As illustrated in FIG. 13B, presentation information 1301 is shown in the group of the product A, and the presentation information 1114 is shown in the group of the product B. In the box 1106, the product C is actually arranged, but presentation information on the product C is not displayed. As illustrated in FIG. 13B, the box 1106 is included in the area of the presentation information 1301 on the product A. The reason for this is because the number of the products C arranged in the box 1106 is less than two, and hence information is not presented as an independent group.

In this example, the product C is included in the group of the product A. However, whether the product C is included in the group of the product A or in the group of the product B may be freely determined. For example, which group the product C is to be included in may be determined based on the relative position of each of the product A and the product B with respect to the product C. Further, for example, the distance between a center position of each group of the product A and the product B and the center position of the product C may be calculated, and a group may be formed that includes the product C in the product having the smaller distance.

Further, the group to which the product C belongs may also be determined so that there is a smaller number of corners of the frame surrounding the group. In FIG. 13B, a case that matches the result when such a method is executed is illustrated. In the case of FIG. 13B, the number of corners of the frame surrounding the group of the product A is four, the number of corners of the frame surrounding the group of the product B is four, and hence the total number of corners is eight.

FIG. 13C is an illustration of an example in which the product C belongs to the product B. In this example, the frame surrounding the group of the product A is the same as that illustrated in FIG. 12B, and the number of corners of that frame is six. Therefore, as illustrated in FIG. 13C, the number of corners of the frame surrounding the group of the product B is six. In FIG. 8A to FIG. 8C and FIG. 10, a case is illustrated in which the information is presented simultaneously for all the grouping result. However, the present invention is not limited to this. The presentation information may be displayed based on time sharing for each group.

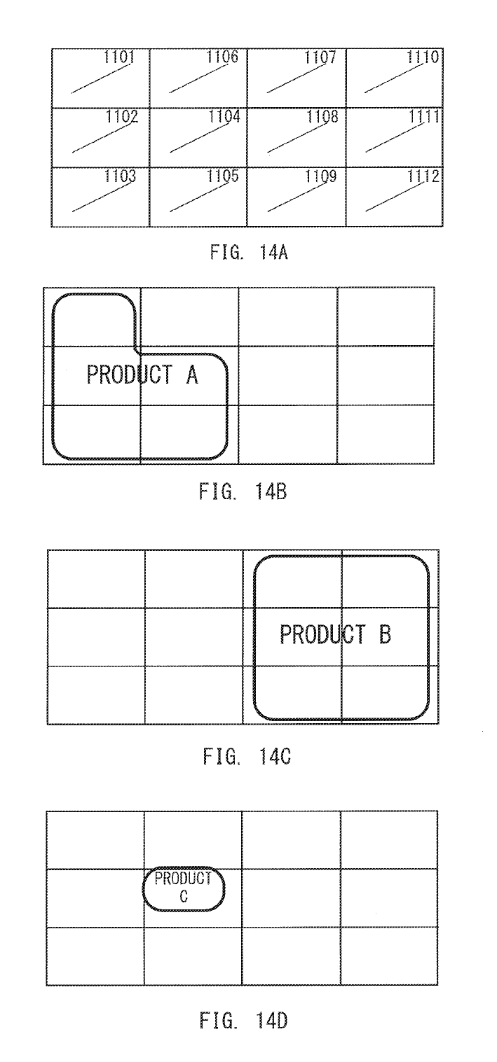

FIG. 14A to FIG. 14D are schematic diagrams of a case in which information is presented for each group based on time sharing. Because FIG. 14A is the same as FIG. 11A, a description of FIG. 14A is omitted here. When presenting information, the presentation information on the groups is switched in order of FIG. 14B, FIG. 14C, and FIG. 14D at each time interval (e.g., seconds) determined in advance. Presentation of the information based on time sharing in this manner enables visibility to be improved. After the information is presented as illustrated in FIG. 14D, the display sequence from FIG. 14B may be repeated again.

In FIG. 8A to FIG. 8C and FIG. 10, a case is described in which the number of characters is reduced as a method of reducing the amount of information as the distance increases. However, the method of reducing the amount of information is not limited to this. The information may be presented without using characters. For example, the information may be presented by displaying only the frames surrounding the groups, displaying the groups in different colors, or displaying icons, images, illustrations, for example, representing a type of the groups.

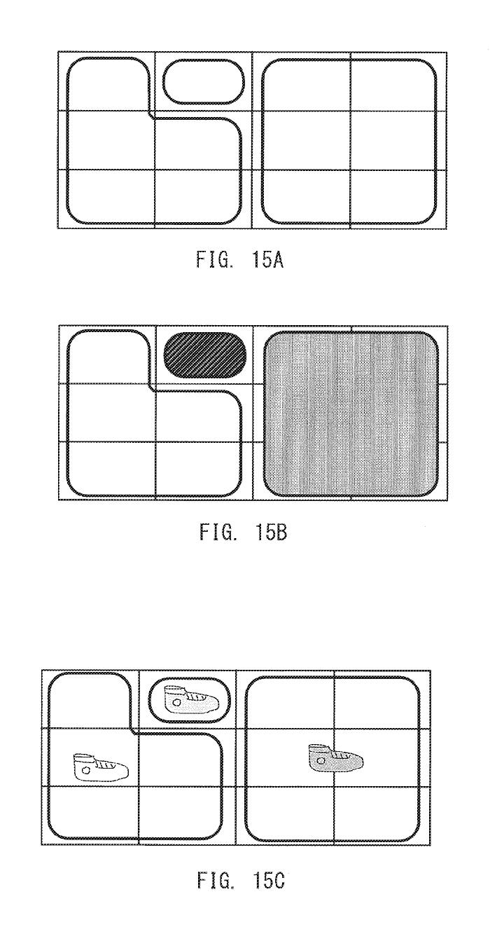

FIG. 15A to FIG. 15C are explanatory diagrams of examples of presenting information without using characters. In FIG. 15A, only the frames surrounding the groups are illustrated. In this case, the user cannot learn detailed information on the product, such as the color, the size, or the model. However, the user can easily visually understand that three types of products are arranged in the 3×4=12 boxes that are illustrated, and the positions in which the various types of products are arranged. Therefore, when verifying whether or not the product that the user himself or herself wants is there, it is not necessary to verify all of the boxes, and the user only needs to verify one box of each of the three types of product.

In FIG. 15B, a case is illustrated in which each group has a different color. In this example, similar to the example illustrated in FIG. 15A, the user cannot learn detailed information on the product. However, as illustrated in FIG. 15B, because each group has a different color, the user can visually understand much more easily the position in which each type of product is arranged, for example.

In FIG. 15C, a case is illustrated in which a picture of a shoe is displayed as an image in place of characters. In this example, similar to the examples illustrated in FIG. 15A and FIG. 15B, the user can easily visually understand the position in which each type of product is arranged, for example. Further, use of an image enables information, e.g., the fact that the product is a shoe, the color of the shoe, and whether the shoe uses laces or is a hook-and-loop type fastener, to be easily visually understood.

Thus, in the examples illustrated in FIG. 15A to FIG. 15C, visibility can be improved by deleting characters in order to reduce the amount of information. Further, through using an image of the product, the user can easily understand information on the product, e.g., the color and appearance of the product.

As described above, according to the present invention, visibility by the user when presentation information is projected can be improved by using a captured image to change the amount of related information. The above-mentioned various embodiments are exemplary embodiments, and various modifications may be made thereto. For example, in the above-mentioned embodiments, a two-dimensional barcode is used as the marker. However, the marker is not limited to a barcode, and any graphic or the like may be used as the marker as long as the graphic or the like is identifiable. A color barcode, for example, may also be used.

Thus, according to the present invention, when related information on an object is to be projected on the object in an environment in which the distance between the projection apparatus and the object to serve as the projection surface is variable, the visibility of the related information can be improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-180978, filed Sep. 14, 2015, and No. 2016-051570, filed Mar. 15, 2016 which are hereby incorporated by reference herein in their entirety.

What is claimed is:

1. An information processing apparatus, comprising:
an image capture unit configured to capture a target object;
a generation unit configured to generate, by using a captured image captured by the image capture unit, presentation information for displaying related information corresponding to the target object at a position specified based on a position of the target object;
an image display unit configured to display an image including the generated presentation information; and
a distance acquisition unit configured to acquire a distance between the target object and the information processing apparatus,
wherein the generation unit is configured to generate, when the captured image and the distance acquired by the distance acquisition unit are larger than predetermined values, the presentation information by changing an amount of information to be included in the presentation information.

2. An information processing apparatus according to claim 1, wherein the generation unit is configured to generate, when the acquired distance is larger than the predetermined value, the presentation information by changing a display mode of the presentation information.

3. An information processing apparatus according to claim 1, wherein the generation unit is configured to generate, when the acquired distance is larger than the predetermined value, the presentation information by reducing the amount of information to be included in the presentation information.

4. An information processing apparatus according to claim 1,
wherein the target object comprises a marker having a known size, and
wherein the distance acquisition unit is configured to calculate a size of a marker area, which is an area taken up by the marker, and to determine the distance by using the calculated size of the marker area and the known size of the marker.

5. An information processing apparatus according to claim 1,
wherein the target object has a known size, and
wherein the distance acquisition unit is configured to calculate a size of an area taken up by the target object, and to determine the distance by using the calculated size of the area and the known size of the target object.

6. An information processing apparatus according to claim 1,
wherein the captured image comprises a plurality of the target objects, and
wherein the generation unit is configured to generate, when the distance is less than the predetermined value, apiece of the presentation information for each of the plurality of the target objects, and when the distance is equal to or more than the predetermined value, a fewer number of pieces of the presentation information than a number of target objects.

7. An information processing apparatus according to claim 1,
wherein the image capture unit comprises an optical image capture unit, and
wherein the distance acquisition unit is configured to calculate the distance based on a focal length of the optical image capture unit.

8. An information processing apparatus according to claim 1,
wherein the image capture unit comprises an optical image projection unit, and
wherein the distance acquisition unit is configured to calculate the distance based on a focal length of the optical image projection unit.

9. An information processing apparatus according to claim 1, wherein the generation unit is configured to control the image display unit so that the image is displayed with respect to the target object in an area that is near the target object and that is an area in which the displayed presentation information is viewable.

10. An information processing apparatus according to claim 1,
wherein the image display unit comprises an optical projector, and
wherein the generation unit is configured to control the optical projector so that the image is displayed in an area that is adjacent to the target object and that has a color gradient of a predetermined value or less.

11. An information processing apparatus according to claim 1,
wherein the captured image comprises a plurality of the target objects, and
wherein the generation unit is configured to group the plurality of the target objects into groups each comprising one or more target objects, and to associate one piece of the presentation information with each of the groups.

12. An information processing apparatus according to claim 11, wherein the generation unit is configured to perform the grouping based on the related information corresponding to the one or more target objects.

13. An information processing apparatus according to claim 11, wherein the generation unit is configured to perform the grouping based on a position of the one or more target objects.

14. An information processing apparatus according to claim 11, wherein the generation unit is configured to generate related information shared by at least two or more target objects among the one or more target objects included in the groups as the presentation information on the groups.

15. An information processing apparatus according to claim 11, wherein the generation unit is configured to reduce the amount of information by deleting characters included in the presentation information when the acquired distance is larger than the predetermined value.

16. An information processing apparatus according to claim 11, wherein the generation unit is configured to calculate, when there are a plurality of combinations of the one or more target objects included in the groups, a similarity degree among the one or more target objects forming the groups, and to determine the combinations of the one or more target objects to be included in the groups based on the similarity degree calculated for each of the groups.

17. An information processing apparatus according to claim 12, wherein the generation unit is configured to calculate, when there are a plurality of combinations of the one or more target objects included in the groups, a distance between the one or more target objects forming the groups, and to determine the combinations of the one or more target objects to be included in the groups based on the distance calculated for each of the groups.

18. An information processing apparatus, comprising:
an image capture unit configured to capture a target object;
a generation unit configured to generate, by using a captured image captured by the image capture unit, presentation information for displaying related information corresponding to the target object at a position specified based on a position of the target object; and
an image display unit configured to display an image including the generated presentation information,
the captured image comprising a target object having a known size,
the generation unit being configured to calculate a size of an area taken up by the target object in the captured image, and to determine an amount of information to be included in the presentation information by using the calculated size of the area and the size of the known target object.

19. An information processing apparatus according to claim 18, wherein the generation unit is configured to generate, when the size of the area is less than a predetermined value, the presentation information by reducing the amount of information to be included in the presentation information.

20. An information processing apparatus, comprising:
an image capture unit;
a detection unit configured to detect, based on a captured image captured by the image capture unit, characteristic information applied to a container having a function for storing an article in the container;
an acquisition unit configured to acquire information on a content of the container based on the detected characteristic information; and
a generation unit configured to generate presentation information for displaying the acquired information on the container and at a position around the container;
an image display unit configured to display an image including the generated presentation information; and
a distance acquisition unit configured to acquire a distance between a target object and the information processing apparatus.
